(19) United States
(12) Patent Application Publication
(10) Pub. No.: US 2013/0064678 A1
(43) Pub. Date: Mar. 14, 2013

(54) JACKET STRUCTURE FOR OFFSHORE CONSTRUCTIONS

(71) Applicant: Henrik Stiesdal, Odense C (DK)

(72) Inventor: Henrik Stiesdal, Odense C (DK)

(21) Appl. No.: 13/699,129

(22) PCT Filed: Sep. 14, 2010
(86) PCT No.: PCT/EP2010/063446

§ 371 Date: Nov. 20, 2012

(30) Foreign Application Priority Data
May 25, 2010 (EP) 10163758.5

(51) Int. Cl. F03D 11/04

(52) U.S. Cl. 416/244 R

(57) ABSTRACT

A jacket structure for offshore constructions, particularly for offshore wind turbines, includes a number of first and second profiles, whereby the first profiles have rods in axial alignment and the second profiles have rods in an angled alignment relative to the first profiles. A number of node members are provided, whereby a connection of aligned profiles and/or aligned profiles and node members is established by connecting means with at least two fastening points and at least one elongate tension element extending between the fastening points. The at least one elongate tension element at least partially penetrates through the respective aligned profiles and/or aligned profiles and node members.

### CROSS REFERENCE TO RELATED APPLICATIONS

This application is the US National Stage of International Application No. PCT/EP2010/063446 filed Sep. 14, 2010, and claims the benefit thereof. The International Application claims the benefits of European Patent Application No. 10163758.5 EP filed May 25, 2010. All of the applications are incorporated by reference herein in their entirety.

### FIELD OF INVENTION

The invention relates to a jacket structure for offshore constructions, particularly a jacket structure for offshore wind turbines, comprising a number of first and second profiles, whereby the first profiles comprise rods in axial alignment and the second profiles comprise rods in an angled alignment relative to the first profiles, and a number of node members.

### BACKGROUND OF INVENTION

Offshore constructions for diverse structures to be installed in the sea are usually necessary in particular for wind power plants, that is wind turbines and represent a constructive challenge as the respective structures have to be erected on the seabed by means of an appropriate foundation. A number of different types of foundations such as monopole-, tripile-, tripod- or gravity-foundations for instance are known from prior art.

Aside, jacket structures are well-known since they represent a constructively simple principle having good mechanical properties particularly due to a high stiffness-to-material-use ratio and thus, are adapted to be erected on sites with high wave-loads. Besides, jacket structures are comparatively cost-effective.

EP 2 067 914 A1 discloses a known jacket structure comprising a number of rod-profiles in axial or angled alignment and a number of node-like members, whereby a connection of the rod-profiles and the node-like members is achieved by welding.

Yet, welding represents a comparatively complex connecting method for establishing a stable connection of the respective parts of the jacket structure. Aside, the used materials must be weldable, which may be deemed as a notable restriction in the selection of possible applicable materials for the jacket structure. Altogether, welded joints for jacket structures are fairly complex in planning and realisation.

### SUMMARY OF INVENTION

It is an object to provide a jacket structure for offshore constructions with an improved connecting principle.

This is achieved by a jacket structure for offshore constructions as described above, whereby a connection of aligned profiles and/or aligned profiles and node members is established by means of a connecting means comprising at least two fastening points and at least one elongate tension element extending between the fastening points, whereby the tension element at least partially penetrates through the respective aligned profiles and/or aligned profiles and node members to be connected.

The invention provides a novel connecting principle for jacket structures representing an essential part of the installation of offshore-constructions such as offshore wind turbines for instance. Thereby, a firm and secure connection or support of the respective aligned profiles and/or node members, that is first profiles and/or node members in an axial alignment and additionally or alternatively second profiles and/or node members in an angled alignment with respect to the first profiles is provided by means of the tension element essentially extending between two fastening points, whereby the respective profiles and/or node members are arranged on the tension element like beads on a string since the tension element at least partially penetrates through the respective profiles and/or node members. In such a manner, the inventive jacket structure provides a high degree of constructive flexibility since the respective profiles and/or node members may be individually and separately arranged on the tension element(s), that is a tailor-made design of the jacket structure is feasible.

Thus, the inventive jacket structure does not require advanced and complex techniques like three-dimensional welding or grouting of the profiles and/or the node members in order to be stably installed. Aside, it is possible that profiles and/or node members made of different materials, that is for example concrete and metal components, may be easily and securely attached to each other since they are firmly held in place by means of the tension element longitudinally penetrating through correspondingly aligned bores, through-holes, channels or the like within the respective aligned profiles and/or node members.

Basically, there are two different possibilities regarding the direction of extension of the tension element(s). On the one hand, the tension element may extend in axial direction between adjacently disposed first profiles and/or node members and/or a grounding pile being anchored to the ground and hence, represents a connection of the jacket structure to the seabed. This embodiment serves as an axial connection of the respective first profiles and/or node members, whereby a grounding pile establishing a firm connection of the jacket structure to the ground may also be part of the connection. On the other hand, the tension element may extend in an angled direction relative to the first profiles between adjacently disposed second profiles and/or node members. This embodiment serves as a connection of the second profiles having an angled alignment. Thereby, the second profiles are connected in between two connecting portions of the node members by means of the inventive connecting means.

Of course, it is possible that respective tension elements extend in axial and angled direction, so that the entire jacket structure is securely held through the tension elements. The length of the tension element mainly depends on the size and number of the respective profiles and/or node members to be connected.

The fastening points may be integrally built with or connected to first profiles and/or second profiles and/or node members and/or grounding piles being anchored to the ground or the fastening points may be integrally built with at least one portion of the tension element. If the fastening points are provided with first profiles and/or second profiles and/or node members and/or grounding piles they are mechanically coupled to the respective components of the jacket structure, whereby the tension element engages in the respective fastening points provided with the jacket structure itself. Thereby, the fastening points are favourably integrally built with the respective parts of the jacket structure. Additionally or alternatively, the fastening points may be provided with at least one portion, that is preferably a free ending of the tension element(s). This embodiment offers an easy way to attach the tension element(s) to the respective components of the jacket structure since the jacket structure itself does not require the provision of fastening points which allows the use of standardised components.

It is preferred, that the tension element comprises a tension wire or a tension bar. Tension wires and/or tension bars may be comparatively loose during the installation or mounting of the respective profiles and/or node members, which is of advantage in terms of leading them through duct-like openings, channels or the like provided with the respective profiles and/or node members, whereby they may be tightened afterwards so as to built a proper connection of the respective profiles and/or node members. Hence, tension wires, cables or the like as well as tension bars, which generally comprise a thread or threaded portion along their outer diameter are an advantageous means in terms of mounting and handling.

In a further embodiment of the invention the first profiles and/or second profiles may comprise at least one connecting portion at their respective free endings supporting the connection with further first profiles and/or second profiles and/or node members. The connecting portions serve as a support of the respective connected first profiles and/or second profiles and/or node members, which is that they assure that they are held in place and in relation to each other, particularly during fastening, e. g. the application of tension to the respective tension element(s). The connecting portions are preferably provided with the free endings of a first and/or second profile, yet other positions along the perimeter of the respective profiles are thinkable.

Thereby, the connecting portion is preferably either a collar or a corresponding ring-like recess. In such a manner, a slight overlap may be provided with the respective endings of adjacently disposed first profiles and adjacently disposed second profiles respectively by increasing or decreasing the respective outer or inner diameter of the respective connecting portion. A first and/or second profile may be provided with like connecting portions, that is a collar or corresponding ring-like recess may be provided with the respective opposite free endings or alternatively with different connecting portions at the opposite free endings, that is one free ending comprises a collar and the opposite free ending comprises a ring-like recess. The same applies for differently shaped connecting portions than collars or corresponding ring-like recesses.

The first profiles and/or second profiles and/or node members may be made of metal, particularly iron-based metal, or concrete, particularly reinforced concrete. These materials comprise good mechanical and further anti-corrosive properties which are essential features for offshore applications. Especially in cases of the first profiles and/or the second profiles and/or node members being made of a metal, anti-corrosive coatings, varnishes or the like may be advantageous in order to enhance the durability against corrosion. Likewise, the concrete may be provided with respective anti-corrosive coatings or anti-corrosive additives.

Thereby, the first profiles and the node members may be made of a weldable metal, particularly cast iron, and the second profiles are made of concrete. In such a manner, the first profiles may be welded to the node members, whereby the welded joint only provides a support in terms of a pre-alignment of the respective adjacently disposed profiles and/or node members. Hence, the welded joint does not comprise any supporting properties and consequently, does not represent a part of the supporting structure of the jacket structure. In addition to cast iron other weldable metals may be applicable.

Alternatively, the first profiles and second profiles may be made of concrete and the node members may be made of a weldable metal, particularly cast iron. In such a manner, adjacently disposed node members may be welded in terms of a pre-alignment. Accordingly, the welded joint does not comprise any supporting properties, but only allows a pre-alignment of the respective node members. In addition to cast iron other weldable metals may be applicable.

Aside, the invention relates to a wind turbine comprising a jacket structure as described before.

### BRIEF DESCRIPTION OF THE DRAWINGS

In the following the invention is described in detail as reference is made to the figures, whereby:

FIG. 1 shows a principle cut-out view of an inventive jacket structure according to a first exemplary embodiment of the invention;

FIG. 2 shows a principle cut-out view of an inventive jacket structure according to a second exemplary embodiment of the invention;

FIG. 3 shows a principle view of a node member of an inventive jacket structure according to a first exemplary embodiment of the invention;

FIG. 4 shows a principle view of a node member of an inventive jacket structure according to a second exemplary embodiment of the invention; and

FIG. 5 shows a principle view of a node member of an inventive jacket structure according to a third exemplary embodiment of the invention.

### DETAILED DESCRIPTION OF INVENTION

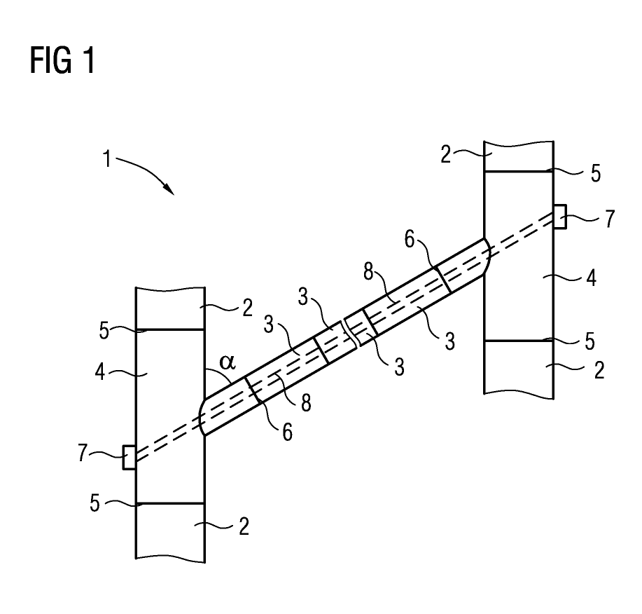

FIG. 1 shows a principle cut-out view of an inventive jacket structure 1 according to a first exemplary embodiment of the invention. The jacket structure 1 comprises a number of first profiles 2, second profiles 3 and node members 4. The node members 4 comprise two connecting sites 5 for interconnecting further node members 4 and/or first profiles 2, that is axially extending rods, whereby the connecting sites 5 are provided with the axial ends of the node members 4. The node members 4 further comprise at least one connecting side 6 provided with the perimeter of the node member 4 for interconnecting second profiles 3, that is rods extending in an angle a relative to the first profiles 2. The entire jacket structure 1 is preferably used as a foundation for an offshore wind turbine (not shown).

As is discernible, a connection of aligned second profiles 3 disposed between the adjacently disposed node members 4 is established by means of a connecting means comprising two fastening points 7 and one elongate tension element 8 extending between the fastening points 7, thereby penetrating through channels provided with the aligned second profiles 3. The fastening points 7 comprise anchors integrally built with the free endings of the tension element 8, whereby the fastening points 7 are stably locked to respective connecting sites 6 provided with the node members 4 in the projection of the tension element 8. The anchors may be detachable from the tension element 8 during the arrangement of the respective second profiles 3. The tension element 8 may be a tension wire, a threaded tension bar or the like.

The inventive jacket structure 1 allows an individual, tailor-made arrangement of separate profiles 2, 3, that is second profiles 3 with respect to FIG. 1 due to its novel connecting-principle which may be compared to the arrangement of beads on a string.

In such a manner, it is even possible to use profiles 2, 3 and/or node members 4 made of different materials, which would be hardly or difficult to connect by the principles known form prior art such as by welding or grouting for instance.

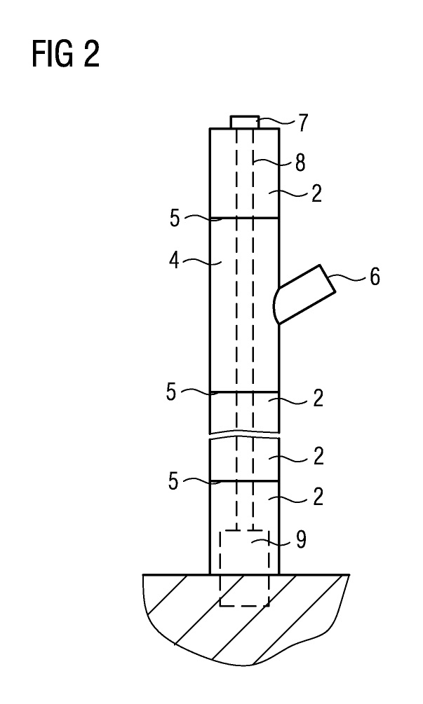

FIG. 2 shows a principle view of an inventive jacket structure 1 according to a second exemplary embodiment of the invention. Thereby, FIG. 2 depicts that the inventive connecting-principle may also be applied for vertically interconnecting first profiles 2 and/or node members 4. Thereby, a grounding pile 9, which is firmly attached to the seabed may comprise a fastening point 7 for the tension element 8, that is one end of the tension element 8 is firmly attached to the grounding pile 9 while the opposite end of the tension element 8 comprises a fastening point 7 in terms of an anchor as is shown in FIG. 1.

It is understood, that the inventive embodiments shown in the FIG. 1, 2 may be combined, so that an inventive jacket structure 1 comprises tension elements 8 extending in axial as well as angled directions relative to the first profiles 2.

According to the invention, the components of the jacket structure 1, that is the first profiles 2, second profiles 3 and the node members 4 respectively may be made of a metal or concrete for instance. Other materials are applicable as well.

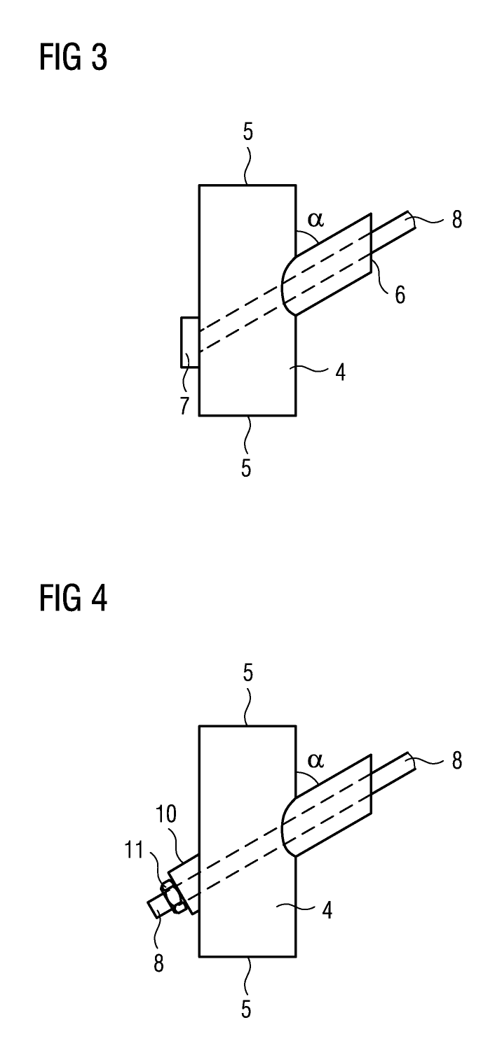

FIG. 3 shows a principle view of a node member 4 of an inventive jacket structure 1 according to a first exemplary embodiment of the invention. Thereby, it is discernible, that the free endings of the tension element 8 may comprise a fastening point 7 in terms of an anchor, which provides a proper and attachment of the tension element 8 within the node member 4.

FIG. 4 shows a principle view of a node member 4 of an inventive jacket structure 1 according to a second exemplary embodiment of the invention. Thereby, the node member 4 comprises a further connecting portion 10 provided with the projection of the connecting site 6 or the tension element 8 respectively, whereby the connecting portion 10 comprises a bore through which the tension element 8 may penetrate, whereby a safe fixation of the tension element 8, which is preferably a threaded bar in this embodiment is provided by respective screw nuts 11 engaging with the tension element 8 and applying a certain tension on it. Of course, tension elements 8 in the shape of tension cables or tension wires may also be fixed at the connecting portion 10 by appropriate fixing means such as appropriate fasteners (not shown).

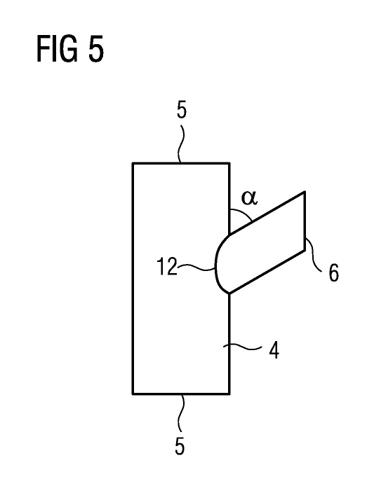

FIG. 5 shows a principle view of a node member 4 of an inventive Jacket structure 1 according to a third exemplary embodiment of the invention. Thereby, a pre-alignment of the connecting site 6 with the remainder of the node member 4 as well as further second profiles 2 to be connected to the free ending of the connecting side 6 may be achieved by a welded joint 12. The same applies to the arrangement of first profiles 2 to the respective connecting sites 5 of the node member 4. The welded joint 12 does not comprise any supporting properties, but only serves as a means for pre-aligning the respective components of the jacket structure 1 which contributes to an eased assembly. In such a manner, all components of the jacket structure 1, that is mainly the node member 4 with its respective connecting sites 5, 6, the first profiles 2 and the second profiles 3 are made of a weldable metal, in particular cast iron.

It is possible, that the first profiles 2 and/or the second profiles 3 comprise at least one connecting portion at their respective free endings which supports the connection with further first profiles 2 and/or second profiles 3 and/or node members 4 in the shape of collars or ring-like recesses, that is they are essentially built by increasing or decreasing the inner or outer diameter of the respective free endings of the first profiles 2 and/or second profiles 3 and/or node members 4. In such a manner, the respective components of the jacket structure are securely held in place and in relation to each other when they are connected and particularly when tension is applied to the tension element 8.

1.-12. (canceled)

13. Jacket structure for offshore constructions, comprising:
a plurality of first profiles and second profiles, wherein the first profiles comprise rods in axial alignment and wherein the second profiles comprise rods in an angled alignment relative to the first profiles, and
a plurality of node members,
wherein connections of aligned profiles and/or connections of aligned profiles and node members is established by connecting means comprising
at least two fastening points and
at least one elongate tension element extending between the fastening points,
wherein the at least one elongate tension element at least partially penetrates through the aligned profiles and/or aligned profiles and node members in order to be connected.

14. The jacket structure according to claim 13, wherein the at least one tension element extends in an axial direction between adjacently disposed first profiles and/or node members and/or a grounding pile being anchored to the ground.

15. The jacket structure according to claim 13, wherein the at least one tension element extends in an angled direction relative to the first profiles between adjacently disposed second profiles and/or node members.

16. The jacket structure according to claim 14,
wherein the at least two fastening points are integrally built with or connected to
the first profiles and/or
the second profiles and/or
the node members and/or
the grounding piles or
wherein the at least two fastening points are integrally built with at least one portion of the tension element.

17. The jacket structure according to claim 13, wherein the at least one tension element comprises a tension wire or a tension bar.

18. The jacket structure according to claim 13, wherein the first profiles and/or the second profiles comprise at least one connecting portion at their respective free ends supporting the connection with further first profiles and/or further second profiles and/or further node members.

19. The jacket structure according to claim 18, wherein the connecting portion is either a collar or a corresponding ring-like recess.

20. The jacket structure according to claim 13, wherein the first profiles and/or the second profiles and/or the node members comprise an iron-based metal or reinforced concrete.

21. The jacket structure according to claim 20, wherein the first profiles and the node members comprise a weldable metal and the second profiles comprise concrete.

22. The jacket structure according to claim 20, wherein the first profiles and/or the second profiles are welded for pre-alignment.

23. The jacket structure according to claim 20, wherein the first profiles and the second profiles comprise concrete and the node members comprise a weldable metal,

24. The jacket structure according to claim 20, wherein the iron-based metal is cast iron.

25. Wind turbine, comprising a jacket structure according to claim 12.
